(19) United States
(12) Patent Application Publication
(10) Pub. No.: US 2006/0238017 A1
(43) Pub. Date: Oct. 26, 2006

(54) Apparatus and methods for covering a wheel

(76) Inventors: Judith A. Samson, Minnetonka, MN (US); Jennifer E. Speas, Stillwater, MN (US); Kevin W. Cyr, Minnetonka, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/113,599

(22) Filed: Apr. 25, 2005

(51) Int. Cl. B60B 7/00

(52) U.S. Cl. 301/37.101

(57) ABSTRACT

Apparatus and methods for covering wheels of a vehicle are disclosed. The apparatus may include a wheel cover having a display region configured to receive a removable covering.

### CROSS-REFERENCE TO RELATED APPLICATIONS

The present application is a continuation-in-part of a U.S. patent application entitled APPRATUS AND METHODS FOR COVERING A WHEEL filed Apr. 6, 2005 by Judith A. Samson, et al. having attorney docket no. 1021-002 for which a serial number has not yet been assigned.

### BACKGROUND OF THE INVENTION

1. Field of the Invention

The present invention relates to wheels for motor vehicles, and, more particularly, to apparatus and methods for covering wheels.

2. Description of the Related Art

Wheel covers are generally circular covers that fit over a wheel for ornamental or protective purposes. Wheel covers are typically made of metal, plastic or a composite of these materials. Typically, wheel covers are secured to the circumferential rim of a wheel. Wheel covers are commonly secured to the rim of the wheel by a plurality of clips or other fasteners which are biased in a number of fashions to a lip about the circumference of a wheel. Wheel covers are typically configured to conform to the size of the wheel and cover substantially the entire circumference of the wheels of a motor vehicle. However, certain wheel covers may include holes or other contours that may expose portions of the wheel for ventilation and/or ornamental purposes. Wheel covers are available in a wide variety of designs are available for securing wheel covers to wheels. Many current wheel cover designs are of complex and expensive to manufacture.

Wheel covers frequently include design elements which attempt to emulate more expensive wheels, such as, for example, cast aluminum or magnesium wheels, wire wheels, among others. Other more complex wheel covers are can include moving parts such as spinners. Still other wheel covers provide more divergent and whimsical designs to personalize a vehicle to the particular tastes of its owner. These wheel covers may be provided with indicia to indicate origin from a particular manufacturer, to support athletic teams and academic institutions, to advertise products, to identify a corporate vehicle by attaching the corporate logo, or simply to personalize a vehicle. Accordingly, a need exists for an apparatus and method which would permit the changing of indicia without the need to acquire different wheel covers. Such an apparatus and method could be used for the cost efficient tailoring of a vehicle's wheels for specific events, for holidays, company promotions, or any other reason that may not justify the expense of purchasing new wheel covers. Most of the present designs or indicia are permanently affixed to, molded in or embossed in the wheel cover. Therefore, vehicle owners are forced to purchase different wheel covers to change the look and style of their wheels. Accordingly, a need further exists for inexpensive apparatus and methods for altering the look and/or style of a wheel.

Some current apparatus and methods for displaying materials on wheel covers include elaborate projection apparatus for projecting or stabilizing designs or logos on their exterior surfaces. In one example, a sophisticated optical-mechanical apparatus creates a holographic image over a wheel. Still other apparatus provide an independently rotatable display surface on the exterior of the wheel cover with a weighted location about its circumference to keep the image on the exterior surface from rotating as the wheel rotates. However, these apparatus are relatively complex and may ad to the un-sprung weight of the wheel. Further, these devices are complex and may be subject to structural failure or malfunction in the harsh environment which wheels are typically operating. Accordingly, a need exists for a relatively simple, robust and lightweight apparatus and method for displaying ornamentation, designs or other indicia on a wheel.

Other prior wheel covers have attempted to magnify images with optically clear lenses secured to their outer surface. The lenses can magnify the decorative image on a decorative wheel cover. These lenses have been attached to the rim of the wheel by clips or by magnets. However, these lenses have not provided for interchanging indicia displayed on the outer surface of the wheel or wheel cover.

Temporary covers have been provided for ornamental purposes and protective purposes. Some of these have been provided for the cleaning of heavy machinery such as farm equipment. In prior apparatus, rigid cardboard wheel covers have been provided to cover and protect the wheels during tire cleaning. These apparatus have been in the form of cardboard covers are attached either magnetically or adhesively to the rim of the wheel for cleaning. These apparatus have not been designed to maintain the covers over the wheels during normal operating conditions. Typically, they have been generally designed for use on stationary vehicles. Accordingly, a need exists for apparatus and methods that will permit the ornamentation of wheels that may be used under normal operating conditions.

Decorative wheel covers have also been developed for temporary and permanent uses. However, these wheel covers have not provided for changing their outward appearance. More particularly, prior wheel covers have not been provided in a configuration that would allow an ornamental sheet material to be applied over a substantial portion of their exterior surface without distorting the sheet material. Accordingly, a need exists for apparatus and methods for permitting ornamental sheet material to be applied to a wheel without distortion of the ornamentation on the sheet material.

### SUMMARY OF THE INVENTION

An apparatus and method in accordance with the present invention may satisfy the above-listed needs as well as providing additional improvements and advantages that will be recognized by those skilled in the art upon review of the present specification.

### BRIEF DESCRIPTION OF THE DRAWINGS

FIG. 1 illustrates a perspective view of an embodiment of an apparatus in accordance with the present invention showing a removable cover secured over at least a portion of a wheel which is mounted on a vehicle;

FIG. 2 illustrates a perspective view of an embodiment of an apparatus in accordance with the present invention showing a removable cover secured over at least a portion of a wheel cover mounted on a wheel which is mounted on a vehicle;

FIG. 3 illustrates a cross-sectional view of an embodiment of a wheel having a removable cover in accordance with the present invention through the center of rotation of the wheel;

FIG. 4 illustrates details of a portion of the cross-sectional view of the wheel having a removable cover as shown in FIG. 3;

FIG. 5 illustrates a cross-sectional view of an embodiment of a wheel and a wheel cover having a removable cover in accordance with the present invention with the cross-section through the center of rotation of the wheel;

FIG. 6 illustrates details of a portion of the cross-sectional view of the wheel cover having a removable cover as shown in FIG. 5;

FIG. 7 illustrates a side view of an embodiment of removable cover in accordance with the present invention showing an exemplary the alignment of the covering with a wheel;

FIG. 8 illustrates a side view of an embodiment of removable cover in accordance with the present invention showing an exemplary the alignment of the covering with a wheel cover mounted on a wheel;

FIG. 9 illustrates a cross-sectional view through the center of rotation of an embodiment of an apparatus in accordance with the present invention including a concave wheel cover having a raised central post and a removable cover shaped to conform to the wheel cover;

FIG. 10 illustrates a cross-sectional view through the center of rotation an embodiment of an apparatus in accordance with the present invention including a convex wheel cover and removable cover shaped to conform to the wheel cover; and

FIG. 11 illustrates a cross-sectional view through the center of rotation of an embodiment of an apparatus in accordance with the present invention including a convex wheel cover having a raised central post and a removable cover shaped to conform to the wheel cover.

All Figures are illustrated for ease of explanation of the basic teachings of the present invention only; the extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in various Figures of the drawings, the same numerals designate the same or similar parts. Furthermore, when the terms “top,” “bottom,” “right,” “left,” “forward,” “rear,” “first,” “second,” “inside,” “outside,” and similar terms are used, the terms should be understood to reference only the structure shown in the drawings as it would appear to a person viewing the drawings and utilized only to facilitate describing the illustrated embodiment.

### DETAILED DESCRIPTION OF THE INVENTION

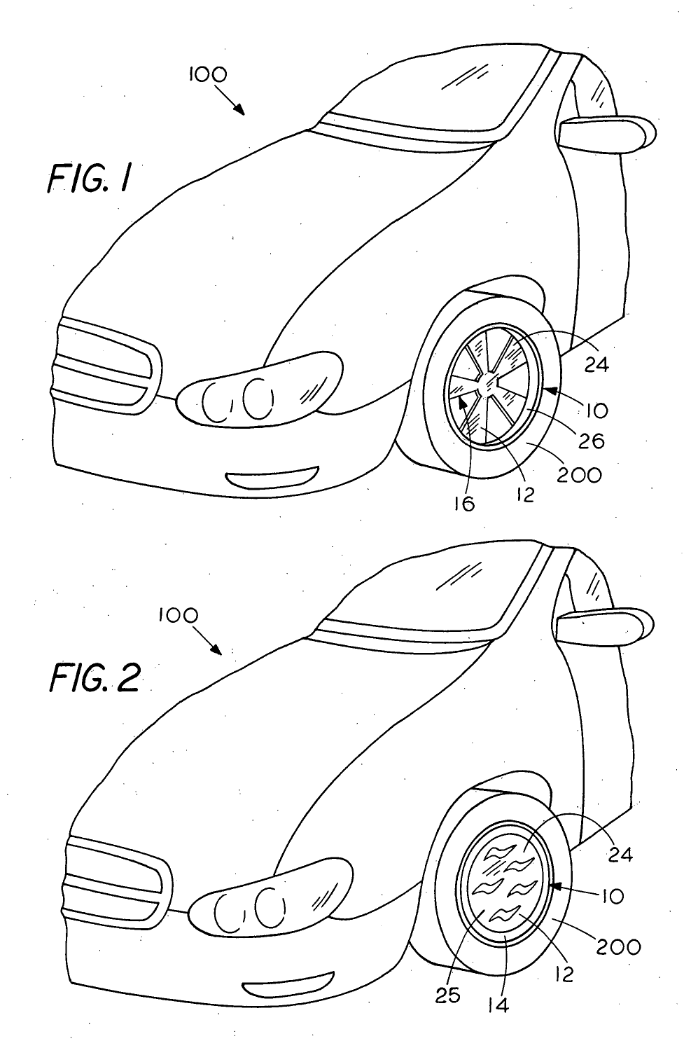

Exemplary embodiments of different apparatus in accordance with the present invention are generally illustrated by FIGS. 1 through 11. Apparatus in accordance with the present invention are shown in the drawings and are generally designated by the number 10.

The present invention provides apparatus and methods for covering wheels. In one aspect, an apparatus 10 can include a removable cover 12 secured to a wheel 16. For purposes of the present description, the wheel 16 should be considered the circular apparatus to which the tire 200 is mounted and which is itself secured to the automobile 100 as is generally illustrated in FIG. 1. In another aspect, an apparatus 10 can include a removable cover 12 secured to a wheel cover 14. For purposes of this description, the wheel cover 14 should be considered an ornamental and/or protective cover that is secured to the outward facing surface of the wheel 16 as is generally illustrated in FIG. 2. The removable cover 12 can provide an ornamental and/or protective element for the wheels 16 or wheel covers 14 of a vehicle 100. The wheel covers 14 and removable covers 12 may be sized to fit wheels having a diameter of 14 inches, 15 inches, 16 inches, 17 inches or wheels otherwise sized as will be recognized by those skilled in the art. In still other aspects, a removable cover 12 may be a strip secured about the lip 26 of a wheel 16. FIGS. 1 and 2 generally illustrate aspects of the present invention as applicable to use in conjunction with a wheel 16 and a wheel cover 14, respectively. FIG. 1 illustrates a removable cover 12 secured to an exterior side 24 of a wheel 16. As illustrated, wheel 16 includes spokes radiating out from center of rotation of the wheel 16 which include a substantially flat exterior portion defining the exterior side 24 in this exemplary embodiment.

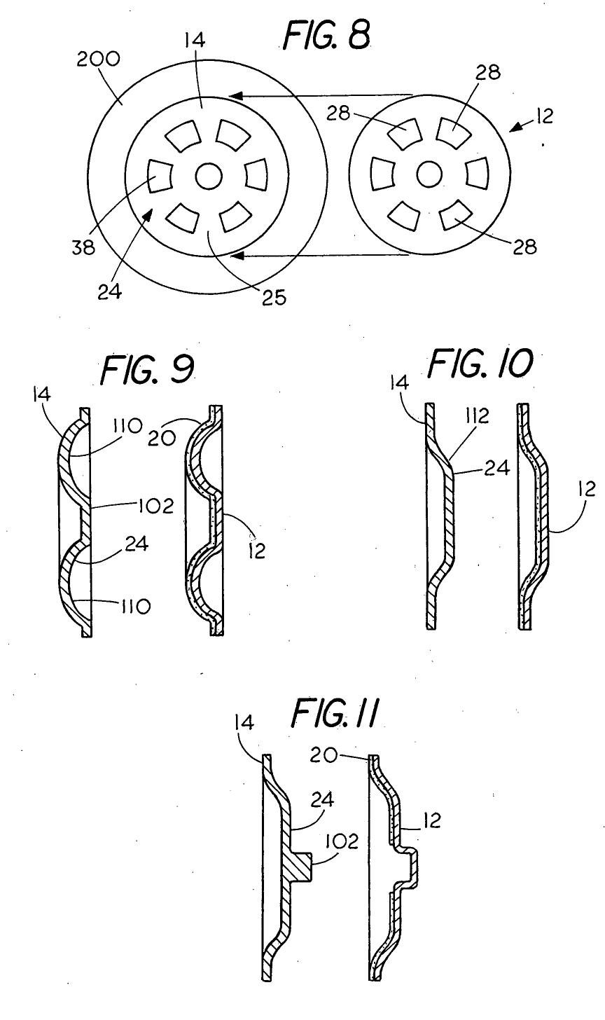

FIGS. 2, 5, and 6 illustrate a removable cover 12 secured to an exterior side 24 of a wheel cover 14. As illustrated, wheel cover 14 is a disk shaped body 15 which defines the exterior side 24 and includes one or more fasteners 23 to secure the wheel cover 14 to a wheel 16. The wheel covers are typically manufactured from plastic, metal, combinations of materials, or other materials as will be recognized by those skilled in the art. Fasteners 23 may include clips, hooks, pressure fitting mechanisms among other fasteners that will be recognized by those skilled in the art upon review of the present disclosure. Typically, fasteners 23 are positioned about the periphery of the disk shaped body 15 and are configured to interlock with a peripheral portion of the wheel 16 to secure the wheel cover 14 to the wheel 16. Exterior side 24 may include a display region 25. Display region 25 typically includes a generally circular shape. The display region 25 may be centered about axis of rotation of the wheel 16 when wheel cover 14 is secured to the wheel 16. The display region 25 may provide the area to secure a removable cover 12. Typically the display region is substantially planar or planar to prevent the need to stretch the removable cover 12 during application of the removable cover 12 to the wheel cover 14. In one aspect, the display region 25 may be sufficiently flat to prevent any distortion to an image on a removable cover 12 applied over the display region 25 which is apparent to the naked eye. In other aspects, the display region 25 is planar or flat to a degree allowed by current wheel cover manufacturing techniques. The display region 25 may extend over the majority of the exterior surface area of the wheel cover 14 as is illustrated for exemplary purposes in FIGS. 2 and 5. In one aspect, the display region 25 may cover more than 60% of the exterior surface area of the wheel cover 14. In another aspect, the display region 25 may cover more than 70% of the exterior surface area of the wheel cover 14. In another aspect, the display region 25 may cover more than 80% of the exterior surface area of the wheel cover 14. In another aspect, the display region 25 may cover more than 90% of the exterior surface area of the wheel cover 14. In yet another aspect, the display region 25 may cover all of the exterior surface area of the wheel cover 14 as is illustrated for exemplary purposes in FIG. 8.

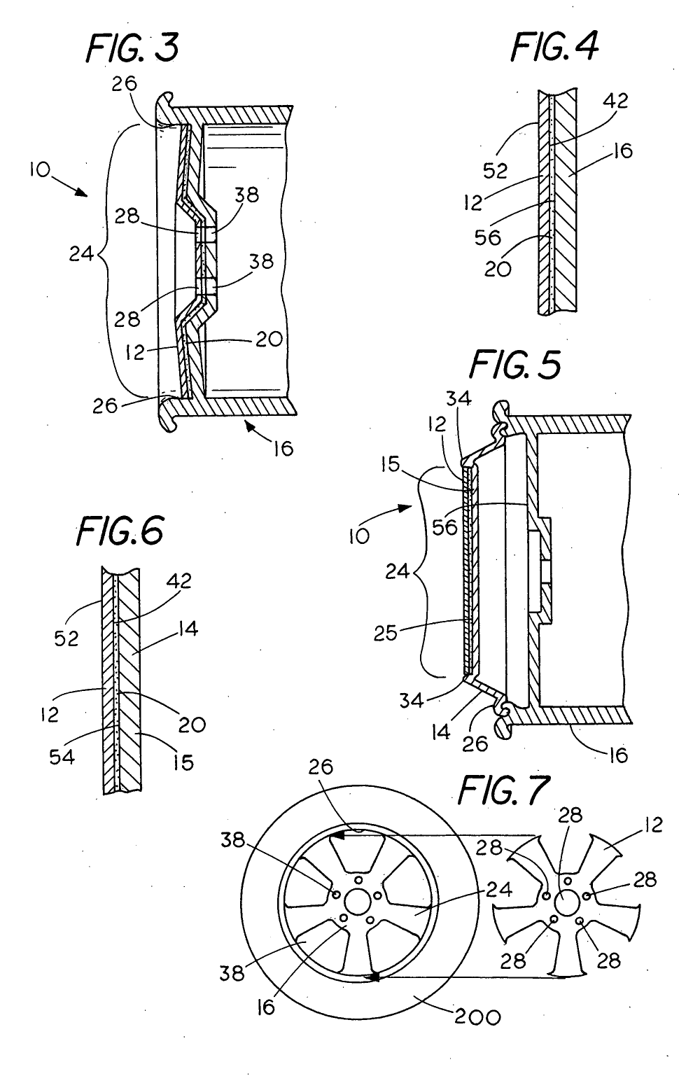

As generally illustrated in FIGS. 1 to 11, the removable cover 12 is generally a layer of material, typically in the form of a sheet, configured to substantially extend across at least a portion of the diameter of a wheel 16 or wheel cover 14. The removable cover 12 is secured to a wheel 16 or wheel cover 14 in a manner which permits the removable cover 12 to be removed from the wheel 16 or wheel cover 14. In one aspect, the removable cover 12 may be removed from the wheel 16 or wheel cover 14 in a single piece. This may permit, but does not require, the ability to reuse a previously applied removable cover 12. The removable cover 12 generally includes an inner surface 42 and an outer surface 52. The inner surface 42 typically includes a layer 20 to facilitate securing the removable cover to a wheel 16 or wheel cover 14. Removable covers 12 may have a substantially circular peripheral shape, as is generally illustrated in FIGS. 2 and 4, a peripheral shape that generally corresponds to an exterior side 24 of the wheel as illustrated in FIGS. 1 and 3, or a peripheral shape desired by the manufacturer to provide the desire look when secured to a wheel 16 or wheel cover 14. In one aspect, the removable cover 12 may extend all the way across the diameter of an exterior side 24 of the visible surface of the wheel 16 or the wheel cover 14. That is, for example, extending circumferentially but excluding the lip 26 of the wheel 16. However, the removable covers 12 may include portions that are cut or cut out to expose ventilation or mounting holes 38 in, to correspond to the spokes or other aspects of the wheel covers 14 or the wheels 16, or that are cut out for ornamental purposes. In one aspect, the removable cover 12 is configured to cover an exterior side 24 of a wheel 16 or wheel cover 16 which is a substantially flat surface. For example, wheels 16 having spokes or other support elements which present a substantially flat visible surface to which the removable covers 12 may be secured. Similarly, a wheel cover 14 may, for example, include an exterior side 24 that is a substantially flat surface extending about a particular diameter to which the removable covers may be secured as illustrated in FIGS. 2 and 7. In other aspects, the removable covers 12 can be configured to conform to non-planar exterior side 24 of a wheel 16 or wheel cover 14. Some examples of non-planar surfaces are illustrated in FIG. 9 to 11. In these examples, the exterior side 24 curves along a radius extending outward from the center of the wheel 16 or wheel cover 14. In other examples, the exterior side 24 may curve along a line perpendicular to a given radius extending outward from the center of the wheel 16 wheel cover 14. In still other examples, the exterior side 24 may include more complex curves defining its surface that include curves along a radii extending outward from the center and curves along lines perpendicular to radii extending outward from the center of the wheel 16 or wheel cover 14.

The removable cover 12 is typically formed from a material that may be secured to a wheel 16 or a wheel cover 14. The removable cover 12 is typically formed from a flexible material to permit it to conform to the shape of at least a portion of the wheel 16 or wheel cover 14 to which it may be secured. In some cases, the removable cover 12 may be formed from a material that can be stretched to help the material to conform to and/or fully cover the exterior side 24 to which it is being secured. Further, stretching allow for proper fitment regardless of variations in the size due to manufacture or temperature of the wheels 16, the wheel covers 14 and/or the removable cover 12 over which the removable cover 12 is configured to be secured. However, the material may be rigid or substantially rigid in applications where the cover 12 is configured to cover a substantially planar surface or where the cover 12 may be preformed to conform to a non-planar shape of a wheel 16 or wheel cover 14. The removable cover 12 may be formed from a plastic, rubber, synthetic rubber, silicone, cellulose based material, among others as will be recognized by those skilled in the art upon review of the present disclosure. In one aspect, the material may be a vinyl or a vinyl based material. Further, the removable cover 12 may be formed from a composite material. The material may be selected for its ability to resist the affects of weathering from contact with debris, ultra violet radiation, water, salt, among others.

The removable cover 12 may be formed a translucent or an opaque material. If translucent, the removable cover 12 may include designs and/or indicia on the inner surface 42 and/or the outer surface 52 that may be visible when the removable cover 12 is secured to the wheel surface 56 of a wheel 16 or the wheel cover surface 54 a wheel cover 14. Further, when translucent, the material may be clear to show the finish of the underlying wheel 16 or wheel cover 14 or it may be tinted to alter the appearance of the underlying wheel 16 or wheel cover 14. If opaque, the removable cover 12 may include designs and/or indicia that are affixed on an outer surface 52 or that are integral within the material of the removable cover 12 itself such that the designs and/or indicia may be visible when the removable cover 12 is secured to the wheel surface 56 of a wheel 16 or the wheel cover surface 54 a wheel cover 14. The designs and/or indicia may include such things as a uniform or varying colors, patterns, logos, abstract designs, pictures, wording, or combinations thereof. The material may also include embossments, surface tooling, sculpted ornamentation, or similar decorative aspects.

The removable cover 12 may have a layer 20 of pressure sensitive adhesive on the inner surface 42 of the removable cover 12 to secure the removable cover 12 to a wheel 16. Pressure sensitive adhesives are available in a wide variety of chemical compositions or systems. Some of the most common types of systems include acrylic and methacrylate adhesives, rubber-based pressure sensitive adhesives, styrene copolymers, and silicones. Acrylic adhesives are known for excellent environmental resistance and fast-setting time when compared with other resin systems. Acrylic pressure sensitive adhesives often use an acrylate system. Ethylene ethyl acrylate or ethylene methyl acrylate copolymers are used to form hot melt pressure sensitive adhesives. Natural rubber, synthetic rubber or elastomer sealants and adhesives can be based on a variety of systems such silicone, polyurethane, chloroprene, butyl, polybutadiene, isoprene or neoprene. Rubber and elastomers are characterized by their high degree of flexibility and elasticity (high reversible elongation). Styrene-isoprene-styrene and styrene-butadiene-styrene copolymers are commonly applied in pressure sensitive adhesive applications. Silicone is produced through the hydrolysis and polymerization of silanes and siloxanes. As will be understood by those skilled in the art upon review of the present disclosure, these types of pressure sensitive adhesives, among others, may be used to secure a removable cover 12 to a wheel 16 or a wheel cover 14. Generally, the particular adhesive used will depend on the material of the removable cover 12 and the material of the wheel 16 or wheel cover 14. Further, the mass of the removable cover 12, the aerodynamics of the wheel 16, the shape of the removable cover 12, among other factors will dictate the minimum strength of the bond which should be provided by the pressure sensitive adhesive. In one aspect, the layer 20 of pressure sensitive adhesive may be selected that will more strongly adhere to the removable cover 12 than it does to the wheel surface 56 of the wheel 16 or the wheel cover surface 54 of the wheel cover 14. This may permit the removal of the removable cover 12 from a wheel 16 or wheel cover 14 without leaving residual portions of the pressure sensitive adhesive layer 20.

In other aspects, the removable cover 12 may be electrostatically or magnetically secured to the wheel 16 or wheel cover 14 as will be understood by those skilled in the art upon review of the present disclosure. When magnetically secured, a removable cover 12 or a layer 20 secured or integral with removable cover 12 could be composed of a compliant material with magnetic properties so as to fixably attach removable cover 12 to the exterior side 24 of wheel cover 14 or wheel 16 by magnetic force. Typically, this would require that the wheel cover 14 or wheel 16 is composed of a material which will attract a magnet. Alternatively, apparatus 10 could include a removable cover 12 formed of a single layer of material with magnetic properties so permit removable cover 12 to be secured to the exterior side 24 of wheel cover 14 or wheel 16 by magnetic force when wheel cover 14 or wheel 16 is composed of a material to which can attract a magnet.

FIGS. 3 and 4 illustrate an exemplary embodiment of an apparatus 10 in accordance with the present invention. FIG. 3 shows a removable cover 12 secured over the exterior side 24 of a wheel 16 and extending diametrically about the circumference of the exterior side 24 defined by the lip 26 of the wheel 16. Other removable covers 12 can be sized to extend into the lip 26 at one or more locations or may be sized to cover only a portion of the exterior side 24 of wheel 16. The removable cover 12 further defines a plurality of openings 28 that are positioned to correspond to the holes 38 in the wheels 16. Other removable covers 12 may not include openings 28 or may include additional openings for ornamental, ventilation or other purposes. The embodiment further illustrates a layer 20 of adhesive which is coextensive with the removable cover 12. Other embodiments may include a layer 20 on only a portion of the inner surface 42 of removable cover 12. Further, the embodiment illustrates the ability of a removable cover 12 made from a flexible material to conform to the contours of an exterior side 24 of a wheel 16. Particularly, the embodiment illustrates the potential for a removable cover 12 in accordance with the present invention to follow the contours of an inset hub portion of the illustrative wheel 16. Depending on the material from which removable cover is formed, it may or may not be necessary to include a layer 20 to secure the removable cover 12 in a position which conforms to the central inset hub portion of the wheel of FIG. 3. FIG. 4 illustrates details of the embodiment of FIG. 3. FIG. 4 shows a removable cover 12 having an outer surface 52 and an inner surface 42. A layer 20 is secured to the inner surface 42. The layer 20 is then secured to the wheel surface 56 of wheel 16 to secure the removable cover 12 to the wheel 16.

FIGS. 5 and 6 illustrate another exemplary embodiment of an apparatus 10 in accordance with the present invention. FIG. 5 shows a removable cover 12 secured over the exterior side 24 of a wheel cover 14 on a wheel 16. The removable cover 12 extends across an exterior side 24 defined by the wheel cover lip 34 of the wheel cover 14. Other removable covers 12 may be sized to extend over a wheel cover lip 34, if present, at one or more locations or may be sized to cover only a portion of the exterior side 24 of wheel cover 14. The illustrated embodiment again shows a layer 20 of adhesive which is coextensive with the removable cover 12. Other embodiments may include a layer 20 on only a portion of the inner surface 42 of removable cover 12. FIG. 6 illustrates details of the embodiment of FIG. 5. FIG. 6 shows a removable cover 12 having an outer surface 52 and an inner surface 42. A layer 20 is secured to the inner surface 42. The layer 20 is then secured to the wheel surface 56 of wheel cover 14 to secure the removable cover 12 to the wheel cover 14.

FIG. 7 illustrates the alignment and application of an exemplary embodiment of a removable cover 12 over a wheel 16. As illustrated, the removable cover 12 corresponds to the spokes of a wheel 16. For exemplary purposes, the removable cover of FIG. 7 is also illustrated with openings 24 which may correspond to holes 38 and manufacturers' indicia in the center of the wheel 16. The removable cover 12 may be applied by aligning spokes of the removable cover 12 with the spokes of the wheel 16 and bringing the removable cover 12 and wheel 16 into contact with one another. If there is an unacceptable degree of misalignment, the removable cover 12 or a portion thereof may be removed from the wheel 16 and realigned. Once properly positioned, the removable cover 12 may be firmly pressed to secure it in position such that it may withstand the forces generated as the vehicle 100 to which wheel 16 is mounted is driven. The removable cover 12 may be removed from the wheel 16 by mechanically grabbing a peripheral edge of the removable cover 12 and peeling the removable cover 12 and preferably the layer 20 from the wheel 16. In embodiments where layer 20 is magnetized, the removable cover 20 may also be slid off the wheel 16 in cases where the wheel structure would permit the sliding of the removable cover.

FIG. 8 illustrates the alignment and application of an exemplary embodiment of a removable cover 12 over a wheel cover 14. For exemplary purposes, the removable cover 12 includes openings 28 which correspond to ventilation holes 38 in wheel cover 14. The removable cover 12 may be applied by aligning the openings 28 of the removable cover 12 with the holes 38 of the wheel cover 14 and bringing the removable cover 12 and wheel cover 14 into contact with one another. If there is an unacceptable degree of misalignment, the removable cover 12 or a portion thereof may be removed from the wheel 16 and realigned. Once properly positioned, the removable cover 12 may be firmly pressed to secure it in position such that it may withstand the forces generated as the vehicle 100 having the wheel 16 to which wheel cover 14 is mounted is driven. The removable cover 12 may be removed from the wheel cover 14 by mechanically grabbing a peripheral edge of the removable cover 12 and peeling the removable cover 12 and preferably the layer 20 from the wheel cover 14. In embodiments where layer 20 is magnetized, the removable cover 20 may also be slid off the wheel cover 14 in cases where the wheel structure would permit the sliding of the removable cover.

FIGS. 9, 10, and 11 illustrate embodiments of the invention wherein the apparatus 10 is either pre-formed, flexed and/or stretched to conform to a shape of an exterior side 24 of wheel cover 14 as will be similarly applicable to a wheel 16. FIG. 9 illustrates a wheel cover 14 having a concave surface 110 and a center post 102. The removable cover 12 is illustrated in the conforming shape in which it may be pre-formed, flexed and/or stretched to conform to the shape of an exterior side 24 of the illustrated wheel cover 14. FIG. 10 illustrates a wheel cover 14 having a convex surface 112 on its exterior side 24. Again, the removable cover 12 is illustrated in the conforming shape in which it may be pre-formed, flexed and/or stretched to conform to the shape of an exterior side 24 of the illustrated wheel cover 14. FIG. 11 illustrates a wheel cover 14 having a convex surface 112 and a center post 102. The removable cover 12 is illustrated in the conforming shape in which it may be pre-formed, flexed and/or stretched to conform to the shape of an exterior side 24 of the illustrated exterior side 24. As illustrated in FIG. 11, the layer 20 is not coextensive with the inner surface of the removable cover 12.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A wheel cover, comprising a disk shaped body having at least one fastener positioned about the periphery of the disk shaped body to secure the disk shaped body to a wheel and the disk shaped body including an exterior surface having a display region having a substantially circular shape centered about axis of rotation of a disk shaped body when secured to the wheel, with the display region being substantially planar.

2. A wheel cover, as in claim 1, further comprising the display region is planar.

3. A wheel cover, as in claim 1, further comprising the display region is circular.

4. A wheel cover, as in claim 1, comprising the display region comprising at least 60% of the exterior surface.

5. A wheel cover, as in claim 1, comprising the display region comprising at least 70% of the exterior surface.

6. A wheel cover, as in claim 1, comprising the display region comprising at least 80% of the exterior surface.

7. A wheel cover, as in claim 1, comprising the display region comprising at least 90% of the exterior surface.

8. A wheel cover, as in claim 1, comprising the display region comprising the entire exterior surface.
A wheel cover, as in claim 1, further comprising a removable cover secured over the display region.
